(19) United States
(12) Patent Application Publication
(10) Pub. No.: US 2013/0073302 A1
(43) Pub. Date: Mar. 21, 2013

(54) SYSTEM AND METHOD FOR VISUAL DISPLAY OF BED STATUS BY INTEGRATION OF LOCATION INFORMATION FROM AMBULANCE TRANSPORTS

(71) Applicants: William F. Ryan, Manhasset, NY (US); Rajiv Sankranti, Burnaby (CA)

(72) Inventors: William F. Ryan, Manhasset, NY (US); Rajiv Sankranti, Burnaby (CA)

(21) Appl. No.: 13/423,439

(22) Filed: Mar. 19, 2012

Related U.S. Application Data
(60) Provisional application No. 61/465,310, filed on Mar. 17, 2011.

(51) Int. Cl. G06Q 50/22

(52) U.S. Cl. CPC G06Q 50/22
USPC 705/2

(57) ABSTRACT

A method and system is disclosed that conveys information to various hospital staff including the housekeeping staff regarding the patient inflow and patient outflow from the hospital vis-a-vis medical transport agencies. By providing the hospital staff with information on “outbounds”, the housekeeping staff can process hospital rooms and beds soon after a previous patient is discharged. The system also tracks the status of “inbound” patients, i.e. patients en route to the hospital by way of a medical transport agency along with the estimated time of arrival (ETA) at the hospital. By providing the nursing staff with information that an ambulance is on the way and how long it will take to arrive at the hospital, housekeeping staff will be informed of the need for a clean patient room before an inbound patient even arrives at the hospital.

### CROSS REFERENCE TO RELATED APPLICATIONS

This application claims the benefit of and priority to U.S. Provisional Patent Application No. 61/465,310, filed on Mar. 17, 2011, hereby incorporated by reference.

### BACKGROUND OF THE INVENTION

1. Field of the Invention

The invention generally relates to a hospital bed processing system and in particular relates to a method of efficiently managing the availability of hospital beds to patients by giving advance knowledge of incoming patient pickups and drop-offs by ambulances.

2. Description of the Prior Art

Various factors contribute to the relatively long wait times before a patient is admitted to a hospital. One factor relates to the time required for a hospital bed to be readied for a new patient. When hospitals are busy, patients can have long wait times before being admitted to a hospital room because of the need for the hospital bed and room to be prepared for the new patient. There are two time components to the wait time. One time component relates to the actual time required by the housekeeping staff to prepare a room and bed for a new patient after a former patient has been vacated. Assuming this component is handled as quickly as possible, it will still take some time for the housekeeping staff to prepare a room and a bed. The other component relates to the time it takes for the housekeeping staff to be informed of patients being discharged and admitted to the hospital. Normally, the housekeeping staff is usually notified by a nurse to prepare a room and a bed. Because the nurses are often busy attending their assigned patients, the nurses typically do not notify housekeeping staff right away after a patient has been discharged and vacated a room. In situations in which the hospital rooms are full in the nurse's area except a room which was previously vacated by a patient, nurses may typically wait to inform housekeeping until they are informed by the Hospital Admitting Department or other members of the medical staff that a patient is being admitted in their area. This may occur long after the previous patient has vacated a room. In the meantime, the newly admitted patient must wait for the housekeeping staff to clean and prepare a hospital room and bed. As mentioned above, this may take some time. If the housekeeping staff is busy cleaning and preparing other hospital rooms, the wait time to get to a hospital room for a newly admitted patient can be fairly long.

Various systems are known for keeping track of the status of hospital beds. These systems are described in detail in US Patent Application Publication Nos.: US 2004/0143446 A1; US 2007/0210917 A1; and US 2008/0027754 A1. However, none of the systems deal with the issue of providing the status of a hospital bed to the housekeeping staff in order to optimize the management of the availability of hospital beds.

US Patent Application No. US 2007/0210917 A1 discloses a hospital bed equipped with wireless communication circuitry that allows various attributes relating to the status of the hospital bed to be transmitted over a wireless network to wireless devices carried by caregivers as well as other departments in a hospital including the housekeeping department. These attributes include the patient weight, the location of the bed as well as whether housekeeping is required to clean the hospital bed and/or the hospital room. The housekeeping request data is implemented by a switch located on the hospital bed. In order to request housekeeping, a nurse or other hospital staff activates the switch. The housekeeping staff is then notified of the need for housekeeping in a particular hospital room. Unfortunately, the housekeeping request is not automatic and only occurs when activated by a nurse or other hospital staff. As mentioned above, nurses often do not request housekeeping immediately after a patient is discharged from a hospital room. As such, newly admitted patients may still have fairly long wait times before being placed in their assigned hospital rooms.

US Patent Application Publication No. US 2004/0243446 discloses a system computer network accessible by hospitals as well as ambulances. The system is primarily used to provide status information to ambulances so that no time is wasted transporting patients to hospitals whose emergency rooms are full. The system provides various information to ambulances and fire departments including: whether beds are available in the emergency room; the average wait time in the emergency room; the average processing time in the emergency room as well as incoming patients. The '446 application does not address housekeeping at all. The various wait times are based on the number of patients in the emergency room and the average processing time.

US Patent Application Publication No. US 2008/0027754 A1 relates to a computerized system for matching patients with special needs with specific types of hospital beds that have attributes which accommodate the special needs of the patient. The special needs include both clinical and non-clinical needs. Clinical needs include: whether a patient needs telemetry equipment; whether the bed is suitable for patients of specific gender; whether the patient needs to be isolated and others. Non-clinical needs include: preference for patient privacy; patient entertain and communication preferences; patient room type and patient room location. Much of this information is available from a information already available at the healthcare facility. This information is used to match patients with specific or special needs with accommodating attributes. Although the system provides the housekeeping status of the various hospital beds in the facility, the system does not provide expedite the housekeeping staff to service hospital beds and rooms when a patient is discharged in order to minimize the wait time for new patients to be admitted to hospital rooms.

Thus, there is a need for a system managing the housekeeping staff in order to minimize the wait time for new patients to be admitted to a hospital room.

### SUMMARY OF THE INVENTION

Briefly, the invention relates to a system for minimizing wait times of newly admitted patients waiting to be admitted to their respective hospital rooms. The system utilizes a personal computer and Internet connectivity to provide a graphical display that conveys information to various hospital staff including the housekeeping staff and the nursing staff regarding the patient inflow and patient outflow from the hospital vis-a-vis medical transport agencies. The system keeps track of patient discharges, i.e. “outbounds” By providing the hospital staff with information on “outbounds”, the housekeeping staff can process hospital rooms and beds soon after a previous patient is discharged. By doing so, newly admitted patients can be processed and admitted to their hospital rooms much more efficiently. The system tracks the status of “inbound” patients, i.e. patients en route to the hospital by way of a medical transport agency along with the estimated time of arrival (ETA) at the hospital. By providing the nursing staff with information that an ambulance is on the way and how long it will take to arrive at the hospital, housekeeping staff will be informed of the need for a clean patient room before an inbound patient even arrives at the hospital.

### DESCRIPTION OF THE DRAWING

These and other advantages of the present invention are disclosed in the following description and attached drawing wherein:

FIG. 1 illustrates an exemplary graphical display which forms a part of the present invention showing a list of outbound patients to be picked up at a hospital.

FIG. 2 illustrates an exemplary graphical display similar to FIG. 1 showing a list of inbound patients to be dropped off at a hospital.

FIG. 3 illustrates an exemplary high level data flow diagram illustrating an exemplary communication link between the displays illustrated in FIGS. 1 and 2 and a Data Center in accordance with an embodiment of the present invention.

FIG. 4 illustrates an exemplary high level data flow communication link between the medical transport vehicles, i.e. ambulances and the respective agency to which the medical transport vehicles are associated and between the medical transport agencies and the Data Center.

FIG. 5 is a data flow diagram illustrating the method of gathering and storing GPS location data from various medical vehicles in the field, in accordance with an embodiment of the present invention.

FIG. 6 is a more detailed data flow diagram illustrating a method of gathering vehicle status, patient details, and hospital transport details from an installed Computer Aided Dispatch (CAD) System in accordance with an embodiment of the present invention.

FIG. 7 is a more detailed data flow diagram illustrating in greater detail a method of gathering data representing the status of medical transport vehicles, patient details, and hospital transport details from an installed Computer Aided Dispatch (CAD) System, in accordance with an embodiment of the present invention.

FIG. 8 illustrates controller logic flowchart form used in the method of gathering vehicle status, patient details, and hospital transport details from an installed Computer Aided Dispatch (CAD) System, in accordance with an embodiment of the present invention.

FIG. 9 illustrates controller logic flowchart form used for receiving, processing and publishing hospital transport information, in accordance with an embodiment of the present invention.

### DETAILED DESCRIPTION OF THE INVENTION

The invention relates to a system for minimizing wait times of newly admitted patients waiting to be admitted to their respective hospital rooms. The system utilizes a personal computer and Internet connectivity to provide a graphical display that conveys information to various hospital staff including the housekeeping staff and the nursing staff regarding the patient inflow and patient outflow from the hospital vis-a-vis medical transport agencies. The system keeps track of patient discharges, i.e. “outbounds” By providing the hospital staff with information on “outbounds”, the housekeeping staff can process hospital rooms and beds soon after a previous patient is discharged. By doing so, newly admitted patients can be processed and admitted to their hospital rooms much more efficiently. The system tracks the status of “inbound” patients, i.e. patients en route to the hospital by way of a medical transport vehicle along with the estimated time of arrival (ETA) at the hospital. By providing the nursing staff with information that an ambulance is on the way and how long it will take to arrive at the hospital, housekeeping staff will be informed of the need for a clean patient room before an inbound patient even arrives at the hospital.

The invention utilizes the capabilities of a personal computer and Internet connectivity to graphically display information in a manner which conveys information to the housekeeping staff and the nursing staff and aids in quick comprehension of the inflow and outflow of patients from the hospital vis-à-vis medical transport agencies. In one embodiment of the invention, the system collects patient inbound and outbound information from various medical transport vehicles, for example, ambulances. This information may be provided by the medical transport vehicles by way of mobile communication devices, such as cellular phones, smart phones, personal digital assistants (PDA), laptop computers and the like or a wireless communication link, for example over a public cellular communications network. In embodiments where the system is web-based, information from the mobile communication devices may be conveyed, for example, over the Internet to a Data Center that groups the information from various medical transport vehicles including medical transport vehicles from independently operated agencies by hospital. Inbound and outbound patient information for each hospital is stored in a database and transmitted to the respective hospitals, for example, over the Internet. The information from the Data Center is displayed graphically at the respective hospitals, in a tabular form, for example, within a conventional web-browser, such as, Microsoft™ Internet Explorer™, Mozilla™, or FireFox™ web browsers, at the respective hospitals. The Data Center refreshes the data at regular intervals, for example 5 minute intervals, on a regular basis.

The invention provides a system and a method for gathering information on patient transports to various hospitals by individual by medical transport vehicles operated by one or more independent agencies. In one aspect of the invention, the Data Center includes a controller that extracts various information, such as, vehicle status, patient details, and hospital transport details, by querying the database of an installed Computer Aided Dispatch (CAD) System and securely transmit said information to the Data Center 22. Such CAD systems are known in the art, for example, as disclosed in U.S. Pat. No. 8,005,937, hereby incorporated by reference. In general, such CAD systems include one or more servers located in a central dispatch office These servers h communicate with mobile data terminals installed in mobile transport vehicles, such as ambulances.

In another embodiment of the invention, the system gathers global positioning system (GPS) location information from the various medical transport vehicles in the field transporting patients to hospitals. The GPS information is stored in the Data Center and used to calculate an estimated time of arrival (ETA) at the respective hospital. The GPS data may be retrieved from the various mobile communication devices carried in the medical transport vehicles. For example, for medical transport vehicles equipped with a computer aided dispatch (CAD) system with a GPS based automatic vehicle locator (AVL), the Data Center can poll the CAD systems for the various mobile transport vehicles to determine a current location of a mobile transport vehicle.

For mobile transport vehicles either without a CAD system or equipped with a CAD system that does not include AVL, a dedicated cellular phone can be associated with a medical transport vehicle and used to provide GPS information back to the Data Center. The cellular phone can be programmed to repeatedly and automatically transmit their GPS data back to the Data Center. Alternatively, the Data Center can track the mobile transport vehicles by tracking a dedicated mobile communication device, such as a cellular phone, associated with the mobile transport vehicle. Systems for tracking the locations of remote mobile communication devices, such as cellular phones, are known in the art. An example of such a system is disclosed in U.S. Pat. No. 6,140,956, hereby incorporated by reference. Briefly, such systems track the locations of the various mobile communication devices by polling the devices over a public cellular communications network and requesting the GPS data. A controller, i.e. server, at the Data Center receives and stores the location data transmitted by the dedicated mobile communication devices. In another aspect, the invention provides a method for consolidating information on patient transports to multiple hospitals by multiple EMS (Emergency Medical Service) Providers, the apparatus comprising: a device to store consolidated hospital transport information and a controller to receive hospital transport information from EMS Providers in remote locations.

In another aspect, the invention provides a method for analyzing, and processing information during transport of patients to and from hospitals and makes information available at a hospital. The information may be used by the hospital staff including the housekeeping staff so that hospital beds and rooms can be processed more efficiently.

In an additional aspect, the invention provides a program readable by machine and stored in a computer memory, CD, Read Only Memory (ROM) or the like, embodying a set of instructions executable by the machine to perform the method steps for the graphical display of hospital inflow and outflow information on patients being transported by ambulance agencies.

In a further aspect, the invention provides a program readable by machine and stored in a computer memory, CD, Read Only Memory (ROM) or the like, embodying a set of instructions executable by the machine to gather and store GPS location information from ambulances in the field transporting patients to hospitals.

In an additional aspect, the invention provides a program readable by machine and stored in a computer memory, CD, Read Only Memory (ROM) or the like, embodying a set of instructions executable by the machine to gather, analyze, and securely transmit information on vehicle status, patient details, and hospital transport details from EMS Providers in remote locations.

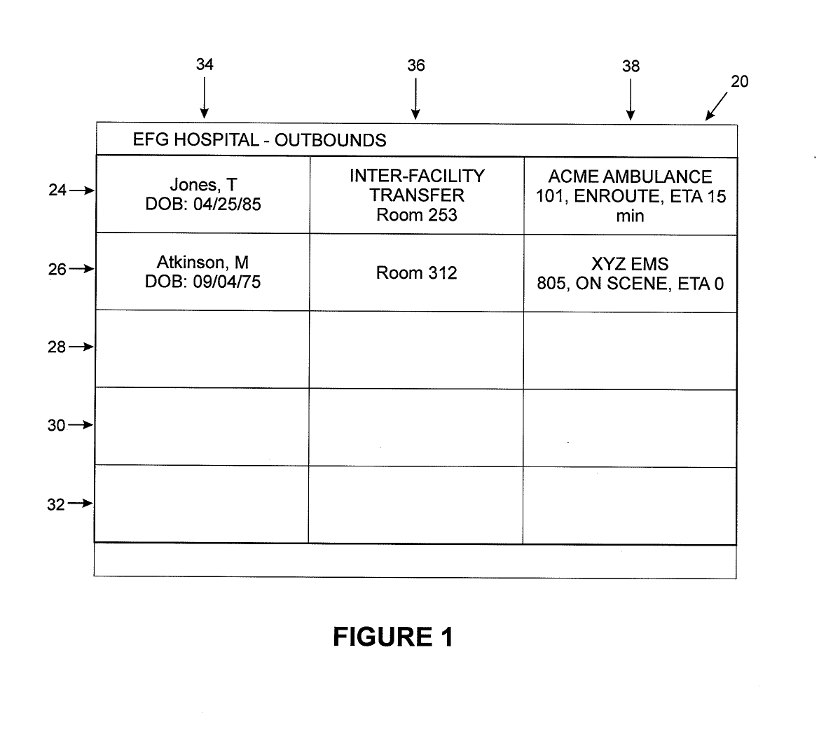

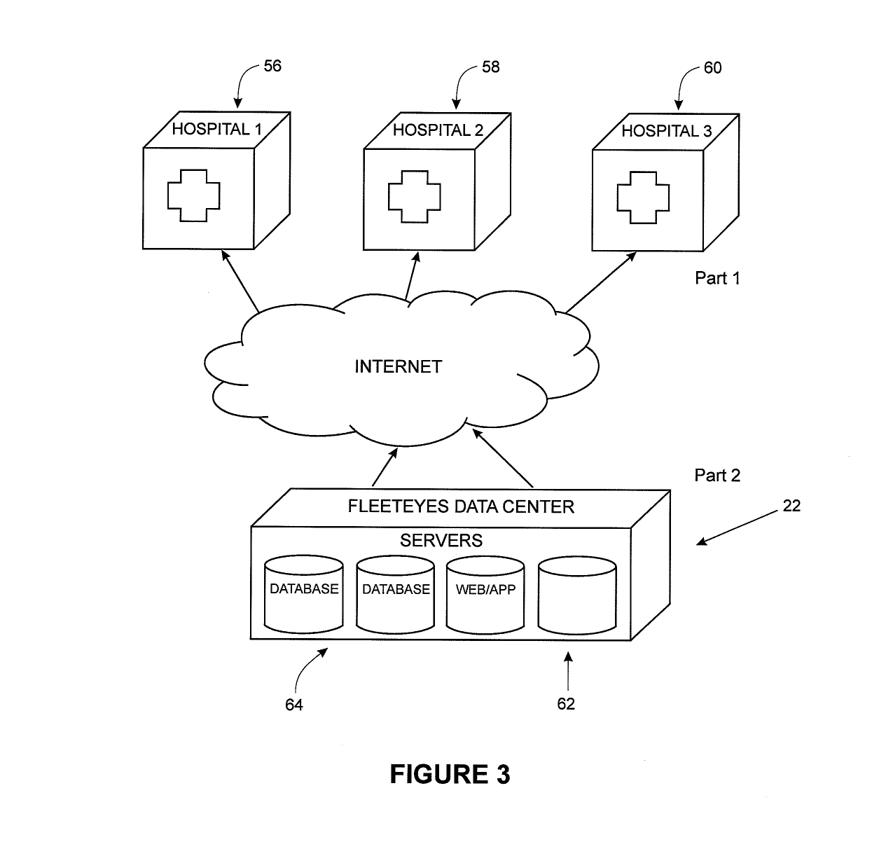

FIG. 1 illustrates an exemplary graphical display, generally identified with the reference numeral 20. The exemplary graphical display 20 may be used for “outbound” patients, i.e. patients being picked up at the hospital. The tabular information is displayed, for example, on a web browser or in a separate program that is provided with an Internet connection. Data for the display 20 is provided by a Data Center 22 (FIG. 3) and may provide information over the Internet to be displayed on the display 20 at the hospital.

The display 20 is implemented as a table with rows and columns. Each row 24-32 of the table represents a patient waiting to be picked up at the hospital. The first column 34 of the table contains the patient name, date of birth, and other identifying information. The second column 36 of the table contains the room number of the patient. The information in Columns 34 and 36 may be obtained by the Data Center 20 from the centrally located CAD system located at the respective medical transport agency.

The third column 38 of the table shows the patient transport agency name, ambulance vehicle number, ambulance status and ETA (estimated time of arrival) of that vehicle at the hospital. The ambulance status is preferably either “Enroute” which indicates that the ambulance has already started its trip to the hospital, or “At Scene” which indicates that the ambulance has arrived at the hospital for pickup.

As discussed above, the Data Center 22 receives GPS data from each medical transport vehicle servicing the hospital. As such, the Data Center 22 is able to keep track of the current location, i.e. geographical position (latitude, longitude) of each medical transport vehicle. Based on this information and knowing the location of the hospitals, the Data Center is able to determine: whether a medical transport vehicle is at a particular hospital; whether a medical transport vehicle is inbound or outbound from a hospital; and the estimated time of arrival (ETA) of medical transport vehicles inbound to a particular hospital as well as the ETA of a medical transport vehicle to a second hospital from a first hospital.

Various information regarding the medical transport vehicle is provided by the Data Center 22 and displayed on the display 20 as the medical transport vehicle approaches a hospital. This information includes the specific medical transport agency, identified in Column 38 as “ACME AMBULANCE”, the vehicle number, identified in Column 38 as “101”, the status of the medical transport vehicle, for example, “ENROUTE” or “ON SCENE”. The interval for the recalculation of ETA and screen refresh may be, for example, one minute. The ETA may be displayed in minutes. The information in the display 20 gives the hospital staff including the housekeeping staff a clear indication of when to expect a patient to vacate a hospital room. The information also provides the housekeeping staff with an indication that a hospital bed will soon be vacated so that the housekeeping staff can schedule processing the hospital room being vacated.

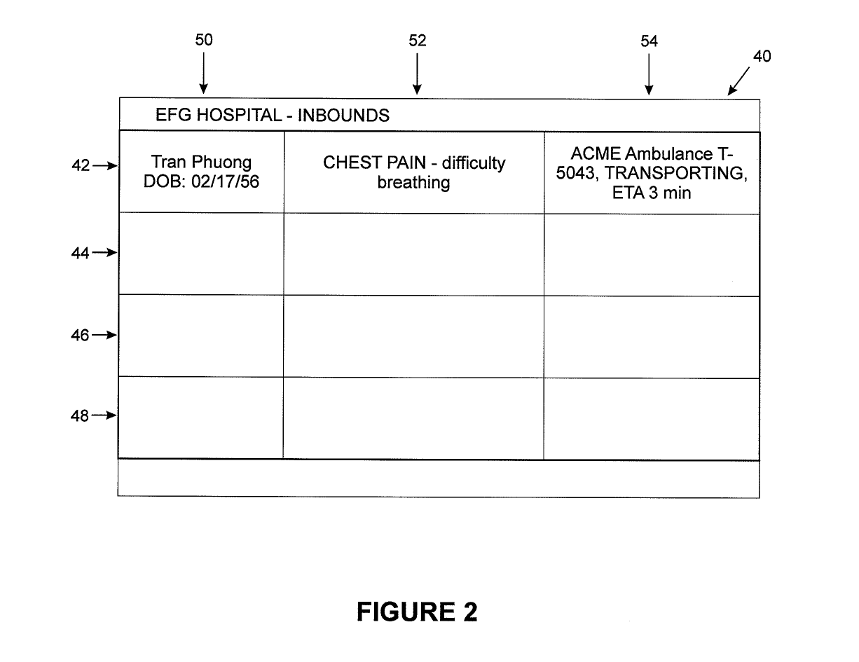

If the transport is an “INTER-FACILITY TRANSFER” to another hospital, i.e. target hospital”, a display in the target hospital will display information, similar to the display illustrated in FIG. 2.

The “ON SCENE” status may be determined by the Data Center 22 by detecting a lack of change of GPS coordinates for a dedicated mobile communication device for a medical transport vehicle for a predetermined period of time, for example 5-30 minutes and the GPS coordinates indicate a location other than the location of the agency to which the medical transport vehicle is associated and other than the location of one of the hospitals in the system. The rows of data on the display, representing patient transports, are automatically cleared once the ambulance has picked up the patient and departed the hospital. Rows of data are added to the display as ambulance agencies dispatch vehicles to the hospital for patient pickup. This refresh operation is performed by the embedded program in the web page that contacts the FleetEyes^{SM} server and downloads the most recent set of data for this hospital.

The “ENROUTE” status is determined by the Data Center 22 by determining if the distance between the medical transport vehicle and a hospital is decreasing. Since there may be several hospitals in the system, the Data Center will determine the distance between one or more of the hospitals until it determines that the distance between one hospital and the medical transport vehicle is decreasing.

FIG. 2 is an exemplary graphical display 40 that illustrates “inbound” patients, i.e. patients being dropped off at the hospital. This display 40 may be a separate standalone display, similar to the display 20, illustrated in FIG. 1 or may be part of the display 20. The display 40 may be implemented as a table divided into rows 42-48 and columns 50-54. Each row 42-48 in the table represents a patient being dropped off at a hospital. The first column 50 may contains the patient name, date of birth, and other identifying information. The second column 52 may contain the details of the medical condition of the patient. The data in Columns 50 and 52 may be obtained by the Data Center 22 from the CAD system, as discussed above.

The third column 54 may show the patient transport agency name, ambulance vehicle number, ambulance status and ETA (estimated time of arrival) of that vehicle at the hospital. The ambulance status is preferably either “Transporting”, or “en route”, which indicates that the ambulance has already started its trip and is transporting a patient to the hospital, or “At Destination”, which indicates the ambulance has arrived at the hospital for patient dropoff. The Data Center 22 determines whether a medical transport vehicle is “Transporting” or “At Destination” by comparing the GPS data of the medical transport vehicle with the location data of the hospital in a manner as discussed above.

As further discussed above, the Data Center 22 also keeps track of the current location of the medical transport vehicle. Based on the current location of the medical transport vehicle relative to the location of the hospital, the ETA of the medical transport vehicle is calculated and updated on the 40 as the vehicle approaches the hospital. The interval for the recalculation of ETA and screen refresh may be, for example, one minute. The ETA is preferably displayed in minutes and gives the hospital staff a clear indication of when to expect the arrival of the ambulance in order to prepare for the patient's arrival by processing a hospital bed and room as soon as possible so that the new patient can be admitted to a hospital room as soon as possible.

The rows 42-48 on the display 40, representing patient transports, are automatically cleared once the ambulance has dropped off the patient. The rows 42-48 of data may be added to the display 40 as ambulance agencies begin to transport patients to the hospital. This data is refreshed by the Data Center 22.

FIG. 3 is a block diagram showing a high level diagram of the invention. In Part 1 of the diagram, exemplary hospitals 56, 58 and 60, identified as Hospital 1, Hospital 2 and Hospital 3 are hypothetical hospitals that subscribe to the system of the present invention. There is no limit to the number of hospitals supported by the system. In one embodiment of the invention, each hospital 56, 58 and 60 is configured to connect to the Internet through an Internet Service Provider by way of a wired or wireless communication link. Each hospital 56, 58 and 60 has one or more personal computers or servers (not shown) running, for example, Windows™, Apple Mac™ or Unix™ operating systems or other operating systems.

Part 2 of the diagram illustrates the Data Center 22 which is similarly connected to the Internet by way of a wired or wireless communication link. The communication between the hospitals 56, 58 and 60 and the Data Center 22 is two way communication. In particular, in one direction, the Data Center 22 pulls clinical and non-clinical patient information from the HIS at the various hospitals 56, 58 and 60, as discussed above, and stores that information in its database 64. In the opposite direction, the Data Center 22 populates the displays 20 and 40, discussed above.

The Data Center 22 may include one or more servers or computer systems, generally identified with the reference numeral 62, and one or more databases, generally identified with the reference numeral 64. The databases may be located at the Data Center 22 or remote therefrom. In one embodiment of the invention, the system can be web based, thus avoiding the need for the personal computers at the hospitals to download the system application program.

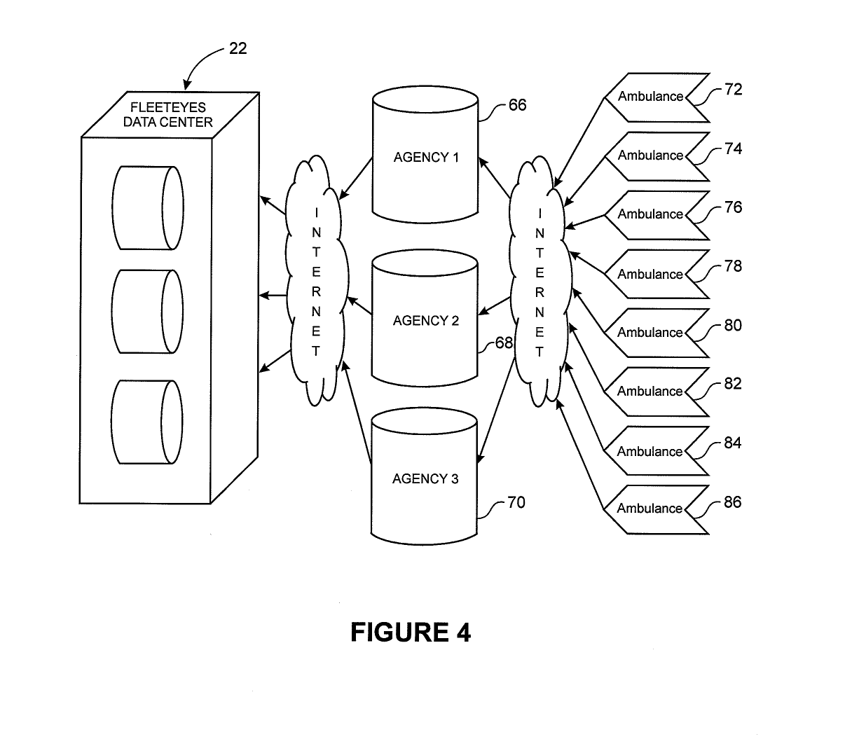

FIG. 4 illustrates the collection of data from various medical transport vehicles 72-86, several agencies 66, 68 and 70, associated with the respective medical transport vehicles 72-80 to be processed and analysed by the Data Center 22. Mobile transport vehicles are owned and operated by private or public Emergency Medical Service Providers (“agencies”). Each provider tracks and records the current status of its medical transport vehicles and patients to be picked up and transported to a particular hospital by way of a CAD system and a radio network. The CAD system allows the service provider to record calls for service, the current status of the service, and locations of medical transport vehicles in the field. The radio network allows dispatchers at the service provider to communicate with the medical transport vehicle crew in the field.

There are a number of medical transport vehicles in the field at any given time that are owned and operated by numerous independent Emergency Medical Service Providers. Medical transport vehicles in a common geographic area typically service the same group of hospitals. However, since these agencies are independent and do not share information among each other, there is no easy way for a hospital to know the status of the medical transport vehicles coming to the hospital for patient pickup or patient dropoff. The Data Center 20 brings together relevant data from disparate agencies, analyzes that data and presents it to hospitals in a format that allows for more effective bed management.

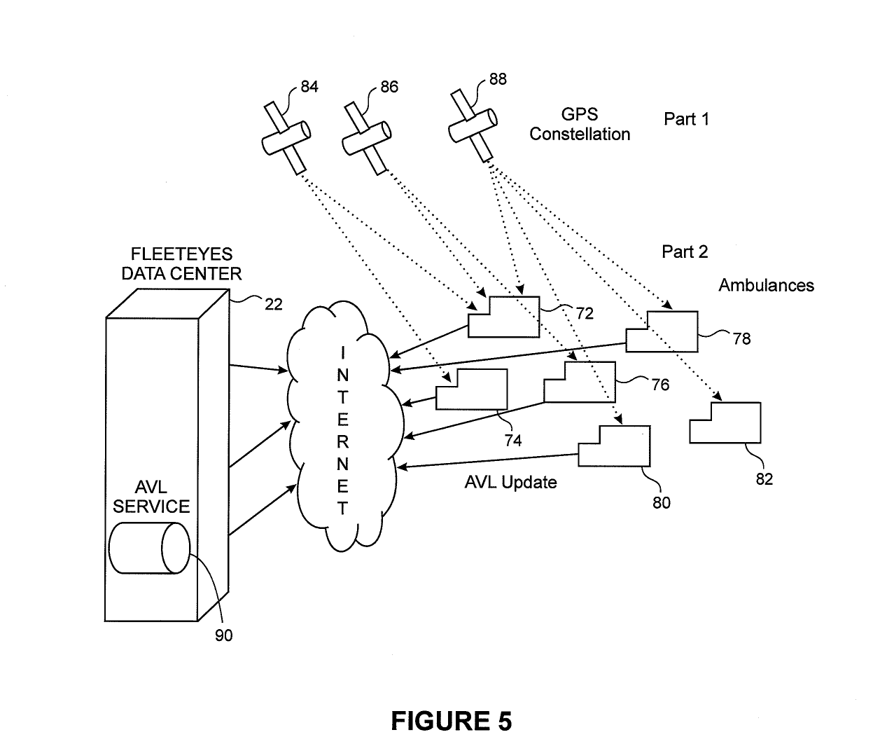

FIG. 5 illustrates an aspect of the present invention that involves continuous tracking of medical transport vehicles in real time. A geographical vehicle position is defined by latitude and longitude. Part 2 of the figure shows a number of medical transport vehicles in the field. As discussed above, for medical transport vehicles equipped with a CAD system that includes AVL, each of those vehicles will include a GPS Modem device. This device has the capability to determine current location of a medical transport vehicle by using GPS satellites, identified with the reference numerals 84, 86 and 88. Each agency The CAD system is programmed so that GPS data is normally transmitted to the centrally located CAD server. Since each medical transport agency will have its own CAD system which may be on different software platforms and formats, each of such CAD systems is programmed so that the GPS device in the respective medical transport vehicle also transmits its GPS data directly to the Data Center 22. In this way, the Data Center 22 becomes a universal AVL for all of the different medical transport agencies and is able to track the locations of all of the medical transport vehicles in the field.

The location information (latitude, longitude and unique identifier of the ambulance) is transmitted to the AVL (Automatic Vehicle Locator) service 90 at the Data Center 22, for example, every 5 to 30 seconds. Data Center 22 records this location information in its database 64 (FIG. 3). This location information is now merged with the medical vehicle status information extracted from the patient transporting agency as discussed above.

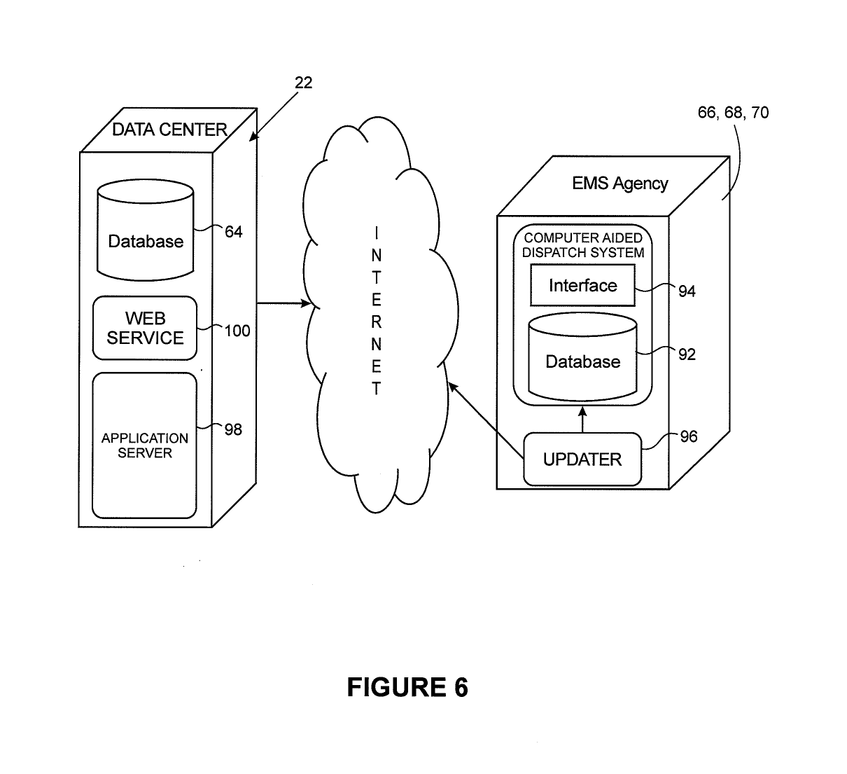

FIG. 6 illustrates the capture of relevant medical transport vehicle status information from individual individual respective medical transport agencies 66, 68, 70 (FIG. 4). As mentioned above, such medical transport agencies 66, 68, 70 use a CAD System to track various information including medical transport vehicle ambulance status, calls for service and other operational information. Such CAD Systems include a centrally located database 92 to store information and a graphical user interface (GUI) 94, which is an executable program that is installed on personal computer hosting the CAD system. The GUI 94 provides various screens for data entry and data display used by Call Takers and Dispatchers to manage the operations of the medical transport agency. Various information, such as, hospital transports, patient details and current vehicle status are stored in the database 92 of the CAD system.

The present invention includes an executable program of machine code, referred to herein as “updater”, identified with the reference numeral 96, installed on a computer at the medical transport agency, which monitors the database 92 of the CAD for new calls for service at hospitals, patients being picked up at hospitals, patients being transported to hospitals, current vehicle status as pertains to transports to various hospitals, and current vehicle locations. This information is then collected by “ updater” , identified with the reference numeral 96 and sent to the Data Center 22. This data is stored in the database 64 at the Data Center 22 and processed by the application server 98. The results of the processing may be stored in the database 64 and transmitted to the hospital, for example, over the Internet by the web service 100.

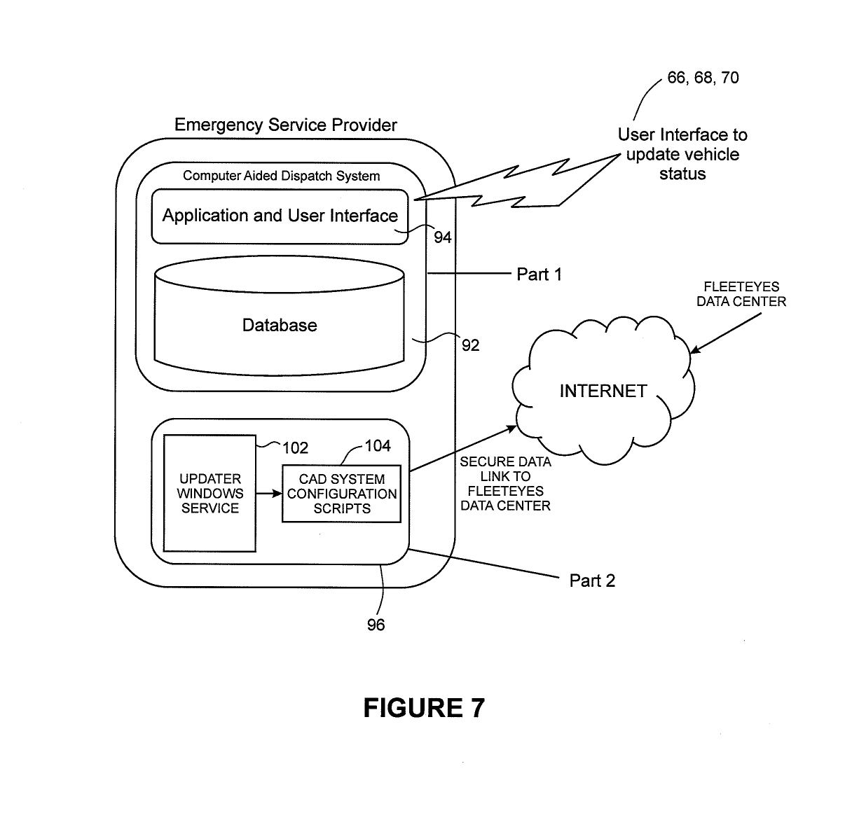

FIG. 7 further illustrates an aspect of the current invention that involves the extraction of relevant data from the medical transport agencies 66, 68 and 70 (FIG. 4) which is sent to the Data Center 22 for processing and analysis. Part 1 of the drawing illustrates an exemplary CAD System at a medical transport agency medical transport agencies 66, 68, 70. This information is used to manage operations as outlined in the previous section. Part 2 of the drawing shows an aspect of the present invention referred to previously as the updater 96. The updater 96 has two main software modules or components components, identified as the blocks 102 and 104 and further identified as “updater windows service” and CAD system configuration scripts 104, respectively. The Updater Service module 102 is an executable program that runs in the background on a computer and monitors the CAD System for new calls for service, new transports from hospitals, new pickups from hospitals, changes to vehicle status, and current vehicle locations. The CAD System Configuration Scripts module 104 is a set of configuration parameters (values) that are stored in a data file along with the Updater Service module 102. These parameters describe the method used to connect to a particular type of CAD System.

CAD Systems are created by third party software vendors and each system has a unique structure for storage of relevant data. The CAD System Configuration module of the current invention describes a set of configuration parameters for each type of CAD system that allows the Updater Service Module 104 at the Data Center to successfully connect to and extract data from a CAD System. Interconnection of different third party CAD systems is disclosed in detail in U.S. Pat. No. 8,005,537, hereby incorporated by reference.

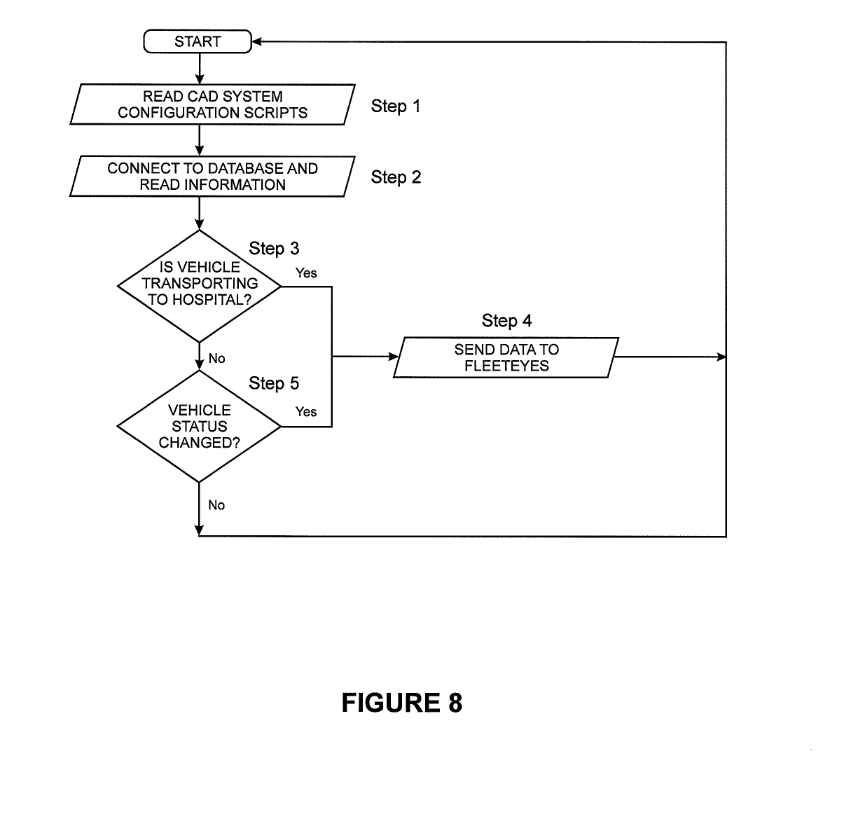

FIG. 8 is a flowchart that illustrates the extraction of data from a CAD System as illustrated by the updater service module 102. The updater service module 102 is a set of executable program codes which preferably uses the following logic to extract relevant data from the Computer Aided Dispatch System:

Step 1, the Data Center 22 by way of the application server 98 reads the CAD System Configuration parameters 104 at the medical transport agency CAD system to determine the method of connection and data extraction;

Step 2, the application server 98 connects to the database 92 of the CAD System to read information;

Step 3, the application server 98 checks a vehicle to see if it is transporting a patient to a hospital or en route to a hospital to pick up a patient;

Step 4, if the application server 98 determines that a vehicle is transporting a patient to a hospital (or en route to a hospital to pick up a patient) it sends the relevant data to the database 92 at the Data Center; and

Step 5, the application server 98 determines a vehicle is not transporting a patient to a hospital or is not en route to a hospital to pick up a patient and goes back to repeat the same operation over and over again in a loop.

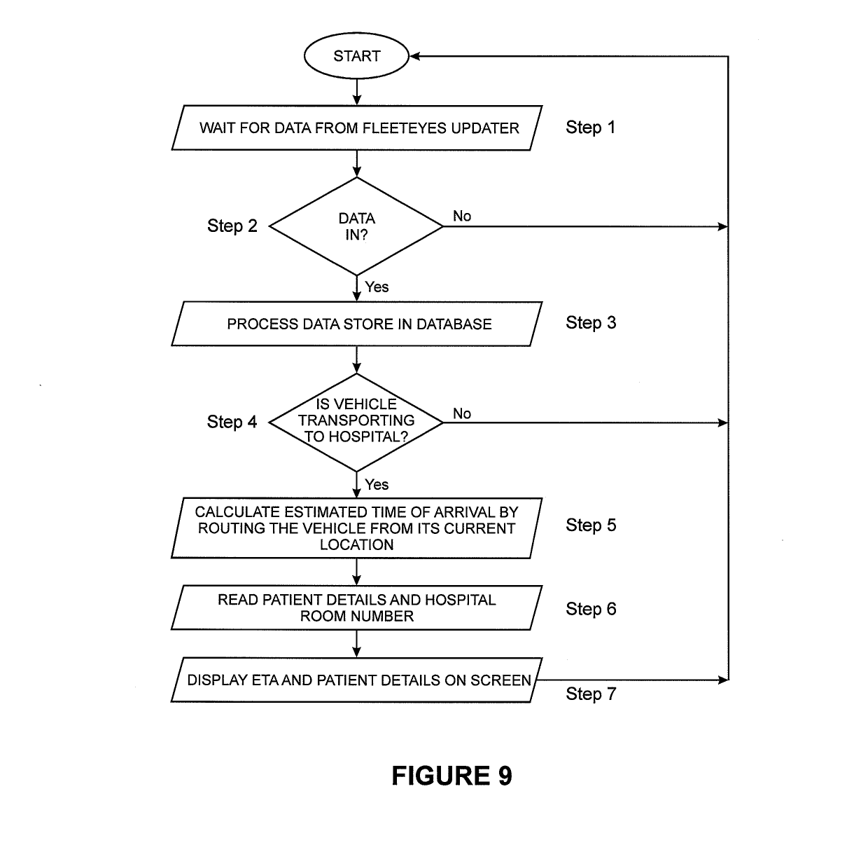

FIG. 9 is a flowchart that illustrates the logic of the application server 98 for processing data from the Updater Service 102 (FIG. 7) that is installed at remote locations, i.e medical transport agencies 66, 68 and 70 (FIG. 4). The Updater Service 102 monitors the System, as outlined above, and sends the relevant data to the Data Center 22 The flowchart of FIG. 9 shows the logic of the application server 98 at the Data Center 22 as data is received from the various Updater Service 102 locations, and includes the following exemplary steps:

Step 1, WAIT FOR DATA—the application server 98 is in a wait state;

Step 2, a decision step, IS DATA IN?—if no data is received, the application server goes back to the receiving state;

Step 3, PROCESS DATA—data is received, processed and stored;

Step 4, a decision step, ANALYSIS—Is the medical transport vehicle transporting a patient to a hospital (or is en route to a hospital to pick up a patient)? If no, the application server 98 goes back to the listening state;

Step 5, the application server has determined that the medical transport vehicle is transporting a patient to a hospital or is en route to a hospital to pick up a patient, and accordingly calculates the estimated time of arrival based on the current location of the vehicle, the location of the hospital and the street network (e.g., the route to the hospital the vehicle will take);

Step 6, the application server 98 reads the patient details and hospital room number of the patient from the stored data in the CAD system and stores this information in its database 64 (FIG. 6); and

Step 7, the application server 98 transmits this information to the hospital and displays this and other relevant data on the website screen which is viewed by hospital staff.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

We claim:

1. A computerized system for managing housekeeping staff at a hospital so that hospital beds and rooms can be made available on a timely basis, the system comprising:
a data center having at least one server and a database, the data center having at least one hospital communication link to a display at a hospital at least one agency communication link to a computer aided dispatch (CAD) system located at a medical transport agency which dispatches at least one medical transport vehicle with a GPS system to transport patients to and from hospitals, the at least one server programmed to perform the following functions:
extract data from the CAD system relating to clinical and non-clinical patient information;
store said data extracted from said CAD in said database;
extract GPS data from said medical transport vehicles;
repeatedly determine the estimated time of arrival (ETA) of medical transport vehicle that are transporting patients to the hospital based upon said GPS data; and
display at said hospital, data extracted from said CAD regarding clinical and non-clinical patient data along with the status data of said medical transport vehicle for outbound patients and the ETA for inbound patients.
